(19) United States
(12) Patent Application Publication
(10) Pub. No.: US 2011/0106943 A1
(43) Pub. Date: May 5, 2011

(54) Host Independent Secondary Application Processor

(75) Inventors: Hemal SHAH, Trabuco Canyon, CA (US); Simon Assouad, Irvine, CA (US); Vinod Lakhani, Laguna Niguel, CA (US)

(73) Assignee: Broadcom Corporation, Irvine, CA (US)

(21) Appl. No.: 12/910,057

(22) Filed: Oct. 22, 2010

Related U.S. Application Data
(60) Provisional application No. 61/258,180, filed on Nov. 4, 2009.
(60) Provisional application No. 61/346,160, filed on May 19, 2010.

(51) Int. Cl. G06F 15/16; G06F 11/30; G06F 3/00

(52) U.S. Cl. 709/224; 713/340; 710/61

(57) ABSTRACT

A system for providing a secondary processing environment to a computer system having a host processor includes a secondary processor configured to perform a processing service, a policy manager configured to control interaction between the secondary processor and the host processor, a service provider configured to provide the processing service to the computer system and a host-state monitor to monitor state of the host processor, wherein the secondary processor operation is based on the state of the host processor.

### CROSS-REFERENCE TO RELATED APPLICATIONS

This application claims benefit to U.S. Provisional Patent Application No. 61/258,180, filed on Nov. 4, 2009, and also claims benefit to U.S. Provisional Patent Application No. 61/346,160, filed on May 19, 2010, both of which are incorporated herein by reference in their entireties.

### BACKGROUND OF THE INVENTION

1. Field of the Invention

The field generally relates to software applications and secondary processors.

2. Related Art

As computer hardware becomes more powerful, the types of functions performed by computer processors continue to increase in complexity. Over the years, specific limited functions have been “offloaded” from main computer processors to a special “co-processor” (also termed “auxiliary processor” or “secondary processor”). Traditionally, for example, math functions and graphics processing functions have been able to be processed by special math co-processors or graphics processing units (GPUs) respectively.

Traditionally, the use of co-processor technology has involved the physical placement of the co-processor in close proximity to the main processor (or central processing unit (CPU)) of the computer. Math co-processors for instance traditionally are placed in a special socket on the motherboard near the CPU. GPUs traditionally have been located in special plug-in interface cards, often fixed in a special interface slot located near the CPU.

One of the key characteristics of the co-processor as it is used traditionally, is that it receives specific processing requests from a running process on the main processor and returns results. The fixed behaviors of the conventional co-processor are only controlled by the set of available parameters submitted with a request from a host processor.

Other key characteristics of traditional co-processor use should be noted. Even as the technology developed, co-processors have generally remained in their traditional “offloading” of functions role.

What is needed are improved methods and systems for having a host-independent co-processor. What is also needed are methods and systems of performing host-independent co-processor services for useful functions such as: management, data synchronization, data storage, multimedia display, network proxy, location awareness and security.

### BRIEF DESCRIPTION OF THE DRAWINGS/FIGURES

The accompanying drawings illustrate the present invention and, together with the description, further serve to explain the principles of the invention and to enable one skilled in the pertinent art to make and use the invention.

FIG. 1 illustrates a host-independent secondary applications processor (SAP) that can be used in a computer system to run applications independent of the host environment state, according to an embodiment of the present invention.

FIG. 2 illustrates a host-independent secondary processor environment and shows in more detail, the SAP from FIG. 1, according to an embodiment of the present invention.

FIG. 3 illustrates a system wherein a secondary applications processor interfaces with a virtual environment and a virtual machine manager, according to an embodiment of the present invention.

FIG. 4A illustrates, in more detail, a secondary applications processor interfacing with a virtual environment and a virtual machine manager, including a secondary processor environment, according to an embodiment of the present invention.

FIG. 4B illustrates, in more detail, a secondary applications processor interfacing with a virtual environment and a virtual machine manager, including a host environment, according to an embodiment of the present invention.

FIG. 5 illustrates a host-independent secondary processor environment implementing host-independent services, including a host independent service provider, according to an embodiment of the present invention.

FIG. 6 illustrates a host-independent secondary processor environment implementing host-independent services, including host independent management services, according to an embodiment of the present invention.

FIG. 7 illustrates a host-independent secondary processor environment implementing host-independent services, including host independent synchronization services, according to an embodiment of the present invention.

FIG. 8 illustrates a host-independent secondary processor environment implementing host-independent services, including host independent storage access services, according to an embodiment of the present invention.

FIG. 9 illustrates a host-independent secondary processor environment implementing host-independent services, including host independent multimedia services, according to an embodiment of the present invention.

FIG. 10 illustrates a host-independent secondary processor environment implementing host-independent services, including host independent network services, according to an embodiment of the present invention.

FIG. 11 illustrates a host-independent secondary processor environment implementing host-independent services, including host independent location services, according to an embodiment of the present invention.

FIG. 12 illustrates a host-independent secondary processor environment implementing host-independent services, including host independent security services, according to an embodiment of the present invention.

The invention is described with reference to the accompanying drawings. The drawing in which an element first appears is typically indicated by the leftmost digit(s) in the corresponding reference number.

### DETAILED DESCRIPTION OF THE INVENTION

The following detailed description of the present invention refers to the accompanying drawings that illustrate exemplary embodiments consistent with this invention. Other embodiments are possible, and modifications may be made to the embodiments within the spirit and scope of the invention. Therefore, the detailed description is not meant to limit the invention. Rather, the scope of the invention is defined by the appended claims.

The embodiment(s) described and references in the specification to “one embodiment,” “an embodiment,” “an example embodiment,” etc., indicate that the embodiment(s) described may include a particular feature, structure, or characteristic. However, every embodiment may not necessarily include the particular feature, structure, or characteristic. Moreover, such phrases are not necessarily referring to the same embodiment. When a particular feature, structure, or characteristic is described in connection with an embodiment, it is understood that it is within the knowledge of one skilled in the art to effect such feature, structure, or characteristic in connection with other embodiments, whether or not explicitly described.

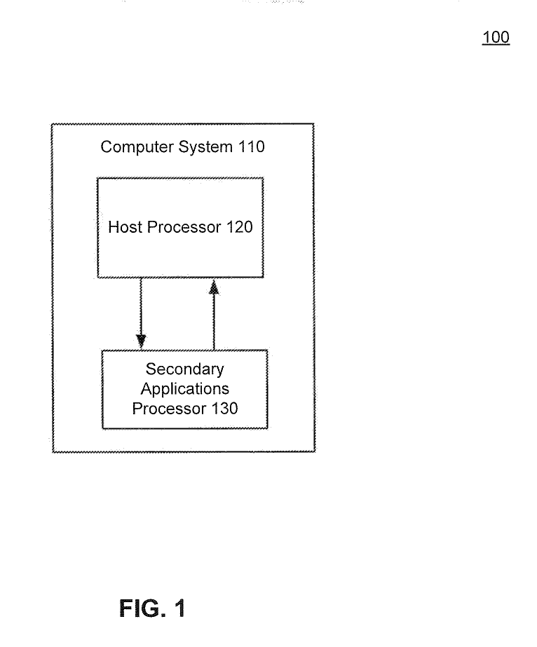

FIG. 1 illustrates an embodiment of system 100, including host-independent secondary applications processor 130 that can be used in computer system 110 to run applications and services independent of the state and context of host processor 120.

Computer system 110 is typically a computer with various computer system configurations, including multi-core multiprocessor systems, minicomputers, mainframe computers, computer linked or clustered with distributed functions, as well laptops, desktops, servers and pervasive or miniature computers that may be embedded into virtually any device. Computer system 110 also may be a networked computer system that forms a part of a data center.

Today's computer systems 110 execute applications on a host processor, e.g., host processor 120 (also known as central processing unit (CPU) or main processor). In modern computer systems host processor 120 can be a collection of interrelated processors or processor cores linked together to jointly perform host application functions.

According to traditional operation, host processor 120 may not be available in all system and operating system (OS) states. For example, in a low-power state or operating system hung (or sleep) state, host processor 120 may not be available to execute applications.

For some types of applications (e.g., email, calendar), it is beneficial to provide an application execution environment that is available in all system and OS states. An embodiment of a secondary applications processor 130 is described herein that is available independently from host environment 210. Because of this host-independent character, different embodiments of SAP 130 are able to perform useful functions that advantageously utilize host-independence, such as: host management, data synchronization, data storage, multimedia display, network proxy, location awareness and security.

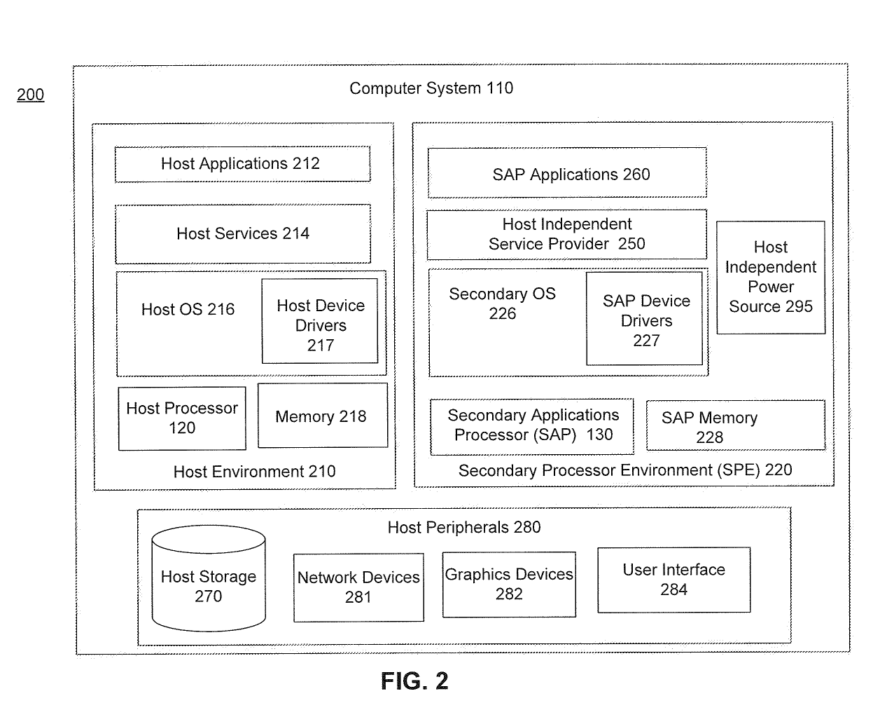

FIG. 2 illustrates an embodiment of system 200, including host-independent secondary processor environment (SPE) 220. In an embodiment, SAP 130 is a component of, and uses the resources of SPE 220. As used herein, SAP 130 and SPE 220 may be used interchangeably to refer to secondary processor components that perform different embodiment functions. In an embodiment, SAP 130 can execute a variety of separate applications, services and functions, using a variety of related components from SPE 220.

FIG. 2 shows host environment 210, secondary processor environment 220 and host peripherals 280. Host peripherals 280 include host storage 270, network devices 281, graphics devices 282 and user interface 284. Host environment 210 contains host applications 212, host services 214, host processor 120, host memory 218 and host operating system 216, such OS containing host device drivers 217. Secondary processor environment 220 contains SAP applications 260, host-independent service provider 250, secondary applications processor 130, secondary applications processor memory 228 and secondary operating system 226, such OS containing secondary applications processor (SAP) device drivers 227.

The figure shows two different execution environments (210, 220) in computer system 110. Secondary processor environment 220 runs SAP applications 260, host-independent services provider 250, and secondary OS 226 on the secondary applications processor 130 and SAP memory 228 independently from the host environment.

Computer system 110 also is shown on FIG. 2 to contain host peripherals 280, such as host storage 270 (e.g., disk drives, NVRAM, and solid state drives), network devices 281 (Ethernet controller, WLAN controller, etc.), graphics devices 282, and user interface 284 (e.g., keyboard, mouse, and display devices). These devices can be accessed by the host environment 120 or secondary processor environment 220 or both. To perform the functions of different embodiments, these devices may or may not be shared by both processing environments (210, 220) simultaneously.

### Host Independence

In an embodiment, secondary processor environment 220 is available in all system states independently from host applications 212 running in host environment 210. Typically, as used herein, “host-independence” refers to different physical and logical independence characteristics of embodiments. It should be noted that the characterization herein of “physical” or “logical” is for example purposes only, and should not be used to limit the scope of the characterization. Aspects of physical independence include the following P1-P4, listed below.

P1: Power source independence: This type of independence described the independence of SAP 130 from the power source of the host processor 120. For example, host-independent power source 295 in FIG. 2 can, in an embodiment, provide power to SAP 130 if no other power is available. This power source independence does not prevent SAP 130 from using a power source that host processor 120 in certain circumstances.

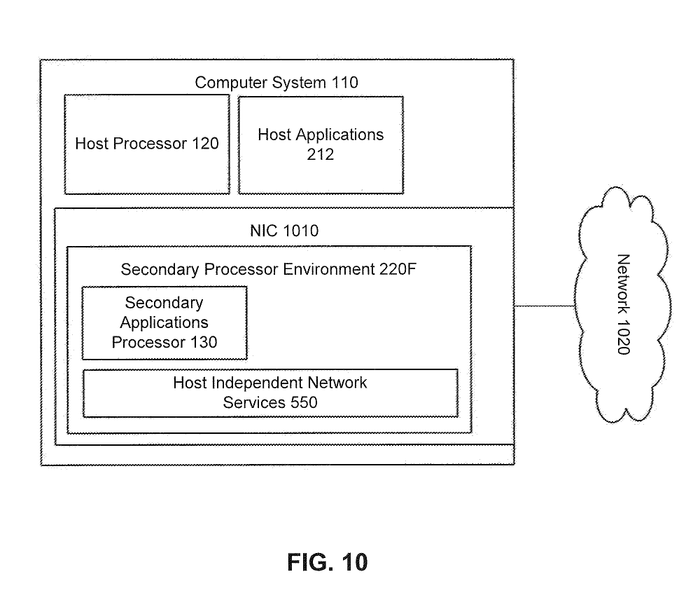

P2: Proximity independence: This type of independence refers to physical proximity, and the concept that SAP 130 does not have to be located in the same physical device as host processor 120. As noted above in the background section, traditionally, supplemental processors have been located in close physical proximity to host processors, e.g., host processor 120. As described below with FIG. 10 below, an embodiment described herein is located in, for example, a host peripheral component, such as a network interface card (NIC).

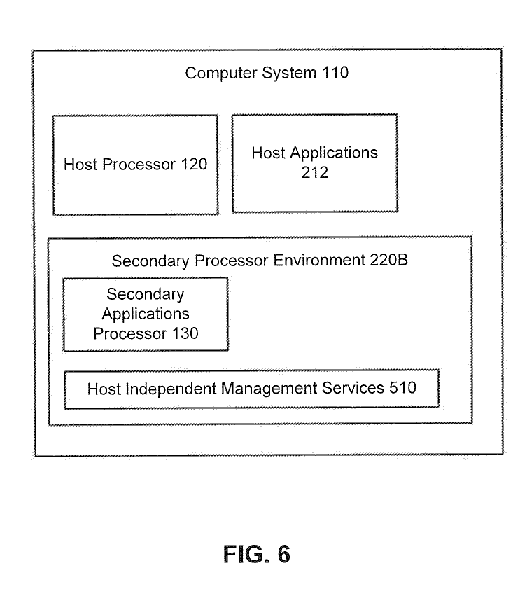

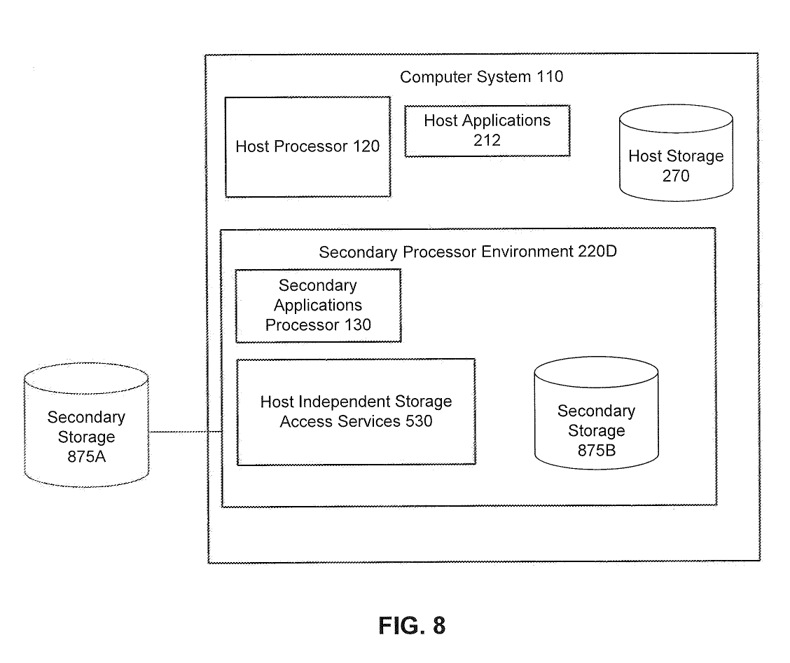

P3: Resource-access independence: This type of independence describes the independent connection that some embodiments have to different system resources in, and connected to, computer system 110. As discussed below with FIG. 8, SAP 130 can independently connect and access different devices, such as secondary storage. Also discussed below with FIG. 6, embodiments of SAP 130 can have access to different portions of host environment 210, e.g., for system configuration purposes.

P4: Client service independence: This type of independence describes the idea that SAP 130 can independently serve clients attached to host environment 210. For example, as discussed below with FIG. 8, if a client of computer system 110 needs to access host internal (270) or host external storage resources, embodiments of SAP 130 can independently service these client requests.

Aspects of logical independence include L1-L2, listed below:

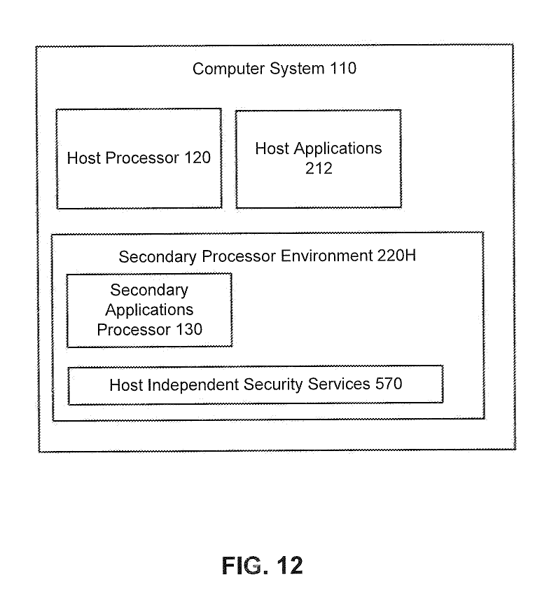

L1: Access and control independence: This type of independence describes that embodiments logically have the capability to limit access and control by host environment 210 to their configuration and data. As discussed below with FIG. 12, certain applications, e.g., security, require the capability to limit access to SAP 130 configuration settings. As noted above in the background section, traditionally, co-processors did not have the capability to have settings independent from host environment.

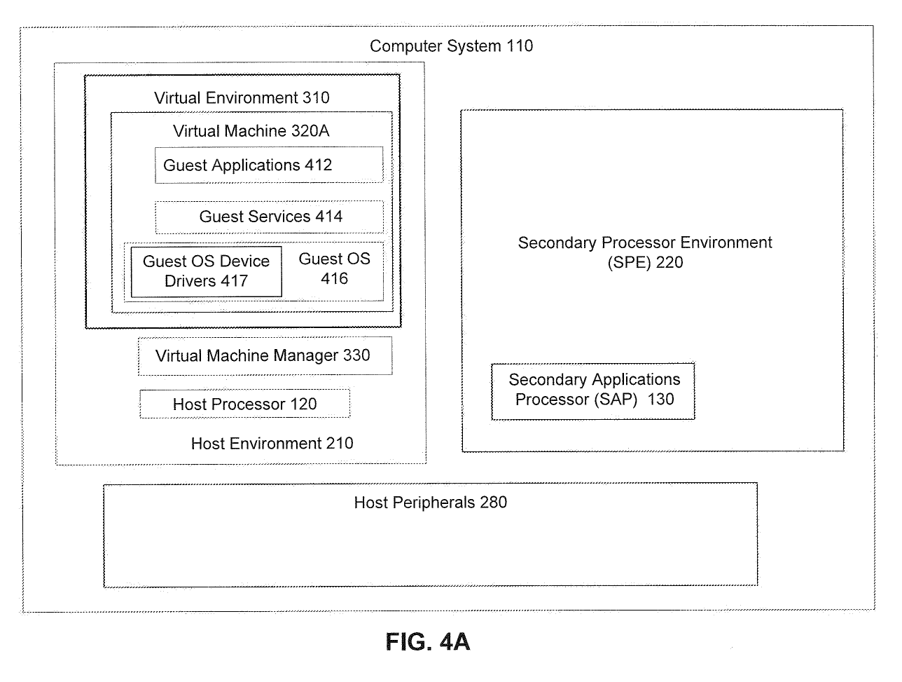

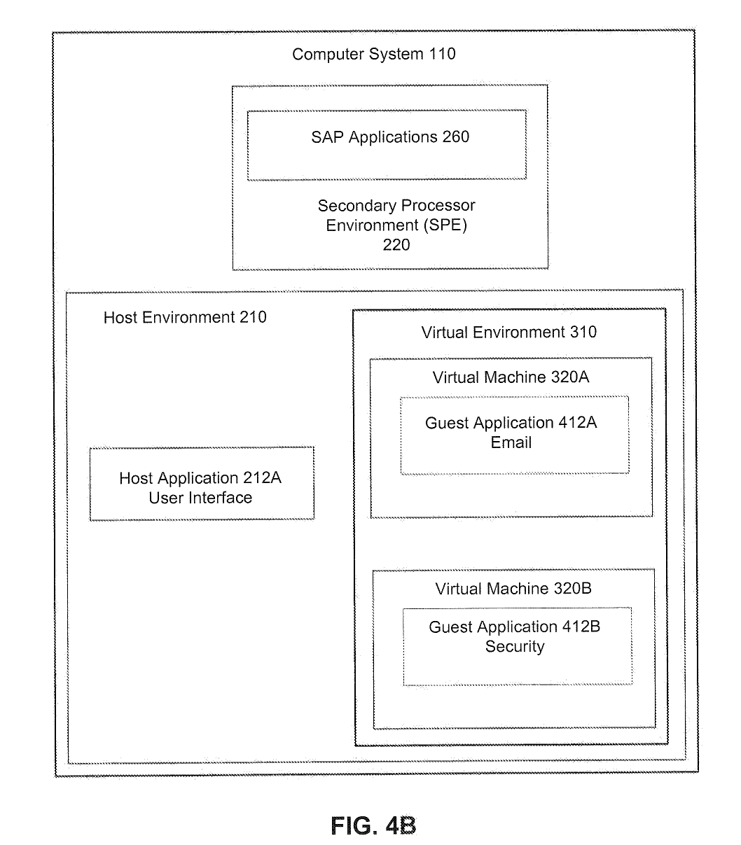

L2: Virtual access independence: As described below with FIGS. 4A-B, because SAP 130 is independent from host processor 120, direct relationships can be established between SPE 220 and virtual environments. In embodiments, the same functions available to assist with host environment 210 functions are available for one or more virtual machines in one or more virtual environments.

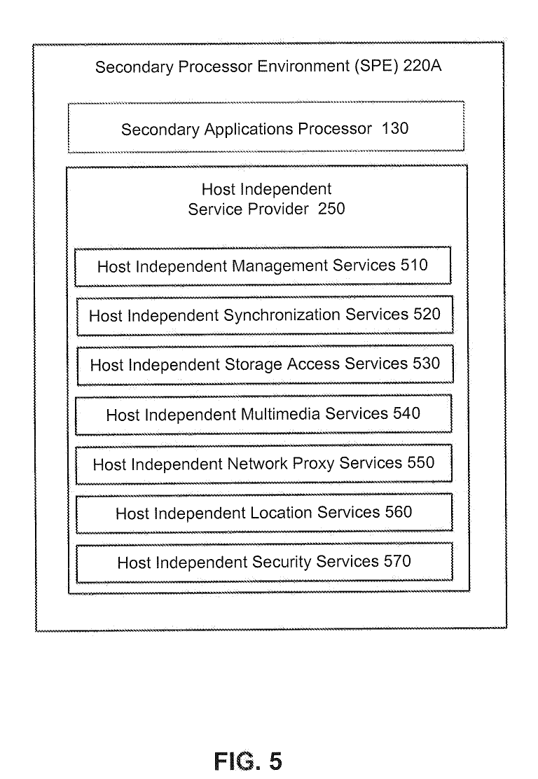

The above noted independence characteristics P1-P4 and L1-L2 are intended to be non-limiting. Different embodiments can have one or more functions and capabilities that can be characterized by one or more of the characteristics. Different characteristics noted above are explained in further detail below with FIGS. 5-12 and related descriptions. One having skill in the relevant art(s) with access to the disclosures herein will appreciate how different embodiments of SAP 130 and SPE 220 can be independent from host processor 120 and host environment 210, and additional advantageous results that can result therefrom.

### Maintaining Host State and Context

In an embodiment, SAP 130 can maintain the state and context of host processor 120. As used herein in an embodiment, to “maintain” the state or context of host processor 120 describes the maintaining as available for use, information corresponding to these information items.

Traditional co-processors do not have the capability to maintain the context and state of host processor 120 applications. As discussed below, this capacity to maintain operational information about host processor 120 enables additional types of features and functions to be performed by SAP 130.

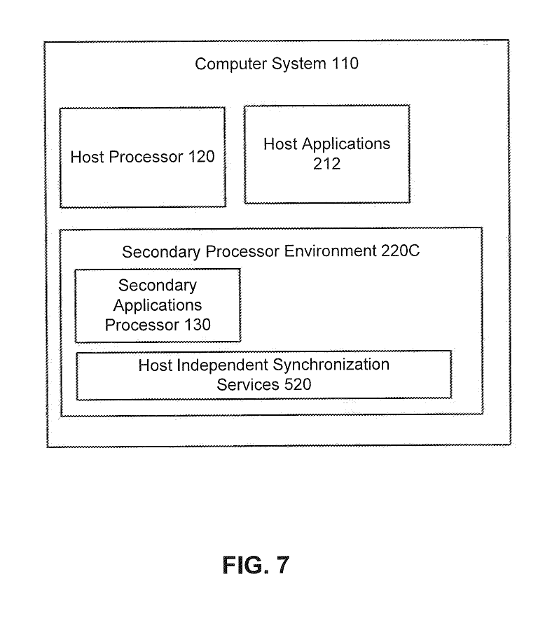

As discussed below with FIG. 7, in an example, SAP 130 can maintain the context and state (e.g., application data) of host applications 212 when host applications 212 are not running or unavailable. When host applications 212 become available, the context/state maintained by SAP 130 is synchronized with host applications 212.

The maintenance of state and context in embodiments also allows an embodiment of SAP 130 to, if system circumstances require, dynamically shift the execution of host applications 212 to be executed as SAP Applications 260. In an embodiment, the application data and execution consistency between host applications 212 running in host environment 210 and SAP applications 260, running in secondary processor environment 220, is maintained in a user transparent way—e.g., the dynamic shifting takes place without negatively affecting the operation of the applications or requiring user intervention.

Power Independence from Host

As noted above with physical independence characteristic P1, using host-independent power source 295, secondary applications processor 130 can remain powered to provide application continuity for computer system 110. Certain functions can still be executed after computer system 110 and associated host environment 210 has been shut down.

In an embodiment, secondary processor environment 220 also promotes power-aware processing by running applications as either host applications 212 or SAP applications 260 depending on the system state and available power.

In an embodiment, this power-aware processing by secondary applications processor 130 enables computer system 110 to run host applications 212 within increased efficiency, and in a power-aware fashion. The low power consumption by the secondary applications processor 130 (a non-limiting example: 300 milliwatts) can extend the battery life in mobile platforms and lower the total cost of computer system 110 ownership.

### Virtual Environments

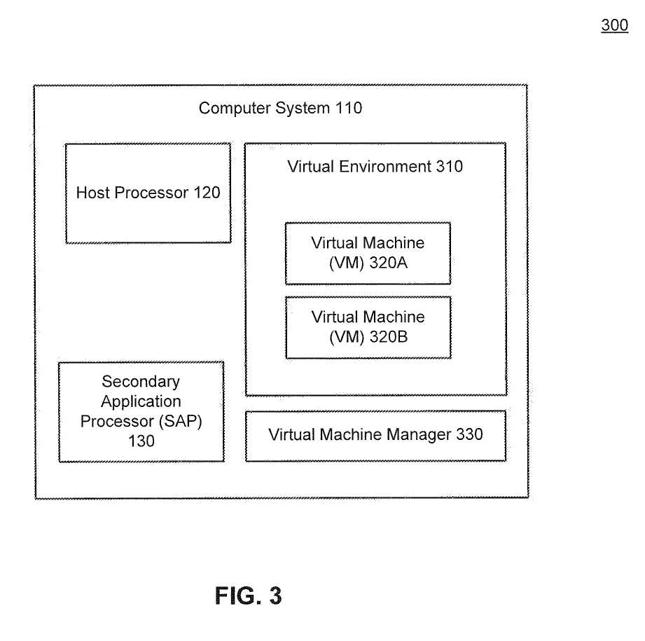

FIG. 3 illustrates an embodiment of system 300 wherein secondary applications processor 130, as described above with FIGS. 1 and 2, interfaces with a virtual environment 310 and a virtual machine manager 330. Virtual environment 310 contains virtual machines 320A-B.

Virtual machines 320A-B are typically instances of a virtual machine as a part of a virtualization platform. One having skill in the art will know of modern virtualization platforms and their implementation. A system having a virtual machine typically provides a complete system platform, which supports the execution of a complete operating system (OS). Virtual machines are typically managed by virtual machine managers (also known as hypervisors), such as virtual machine manager (VMM) 330.

FIG. 4A illustrates, in more detail, an embodiment wherein secondary applications processor 130 interfaces with a virtual environment 310 and a virtual machine manager 330. FIG. 4A shows host environment 210, host peripherals 280 and secondary processor environment 220. Host environment 210 includes virtual environment 310, virtual machine manager (VMM) 330 and host processor 120. Virtual environment 310 includes virtual machine 320A, which includes guest application 412, guest services 414 and guest OS 416. Guest OS 416 includes guest OS device drivers 417.

In an embodiment, SAP 130 maintains the state and context of guest applications 412 executing in the virtual machine 320A in virtual environment 310. In an embodiment, SAP 130 can coordinate the state and context of the three types of applications noted herein (host applications 212, SAP applications 260 and guest applications 412).

For example, in FIG. 4B, computer system 110 is shown with host environment 210 and SPE 220, with virtual environment 310 being depicted inside host environment 210. Each environment is shown executing one or more respective applications (260, 212A, 412A, 412B). In this example, virtual environment 310 is hosting two virtual machines 320A-B, each running a different, complementary application: VM 320A is running an email application (412A), and VM 320B running a security application (412B), and host environment 210 is running a user interface application (212A).

Continuing with this example, as shown in FIG. 4B, SPE 220 is running various SAP applications 260. In this embodiment, SAP applications 260 have information corresponding to the state and context of the other executing applications (212A, 412A, 412B) and can perform, for instance, a synchronizing function with an external host (not shown) for email application (412). This host-independent application synchronizing service is discussed further with FIG. 7 below. In addition, as discussed further with FIG. 12 below, SAP applications 260 can perform a security service to assist the security application (guest application 412B) running in virtual machine 320B. An embodiment of SAP 130 and SPE 220 can use various host-independent services to coordinate the data flows between the different environments. Example host-independent services that can be implemented by SAP 130 are discussed below, such services promoting various considerations, for example security, performance, energy efficiency.

Host-Independent Services

FIG. 5 illustrates an embodiment of host-independent secondary processor environment 220A. Secondary processor environment 220A includes secondary applications processor 130 and host-independent service provider 250. In an embodiment, host-independent service provider 250 can provide services including: host-independent management services 510, host-independent application synchronization services 520, host-independent storage access services 530, host-independent multimedia services 540, host-independent network proxy services 550, host-independent location services 560 and host-independent security services 570.

### Host-Independent Management Services

FIG. 6 illustrates an embodiment of host-independent secondary processor environment 220B implementing host-independent management services 510. In an embodiment host-independent management services 510 is independent from host processor 120.

Host-independent management services 510 utilizes aspects of both the physical and logical independence of SAP 130 noted above. Host-independent management services 510 allow computer system 110 to be configured, managed, monitored, and controlled independently from the system state of host environment 210. This configuration and control of computer system 110, in embodiments, is an example of the physical independence SAP 130 has from host processor 120. In an embodiment, SAP 130 has independent physical access 2875.394 to computer system 110 that is not reliant upon host processor 120. This resource access independence in an embodiment, allows SAP 130 to provide the management services noted below.

For example, in a low power state where the host processor 120 is shut down and host OS 217, host services 214 and host applications 212 are not running, host-independent management services 510 can be used to monitor/control, diagnose/repair, and reconfigure the host environment 210 and host peripherals 280.

Secondary applications processor 130 can also control and configure devices and peripherals on the system, e.g., host storage 270, network devices 281, graphics devices 282, and hardware components (not shown) of user interface 284. These devices can also be powered on or off by SAP 130, thereby allowing the enforcement of energy efficiency and conservation policies.

An embodiment of host-independent management services 510 can control and configure the system devices noted above. These configuration, diagnostics, and repair functions are performed independently from host environment 210. As discussed below with FIG. 8, for example, maintaining independent control over system configuration and having access to secondary storage for recovery, can improve user experience.

As noted above with FIGS. 4A-B, host-independent application services can be used with one or more virtual machines 320A-B. Host-independent management services 510 can work with VMM 330 to provide the management features noted above to virtual environments 310.

### Host-Independent Application Synchronization Services

FIG. 7 illustrates an embodiment of host-independent secondary processor environment 220C implementing host-independent application synchronization services 520. FIG. 7 depicts computer system 110 as containing host processor 120, host applications 212 and secondary processor environment 220C. Secondary processor environment 220C includes secondary applications processor 130, and host-independent synchronization services 520.

Host-independent application synchronization services 520 are used in an embodiment, to maintain the context and data of host applications 212 when host applications 212 are not running or unavailable. The application context/data maintained by secondary processor environment 220C is synchronized with host applications 212 when they are running in host environment 210. For example, this service can retrieve latest emails for an email client host application 212 when host environment 210 is shut down.

In an example, a user executes an email application on in host environment 210 and secondary applications processor 130 synchronizes with host-independent application synchronization services 520. In different embodiments, this synchronization can be performed at different times based on different considerations, e.g., if the main system is powered off, SAP 130 can perform a background synchronization at a time when energy efficiency is maximized.

In an embodiment, the application data and consistency between host environment 210 and secondary processor environment 220C is maintained in a user transparent way, e.g., automatically, without user supervision.

As noted above with FIGS. 4A-B, host-independent application services can be used with one or more virtual machines 320A-B. The host-independent application synchronization services 520, as noted above with FIG. 4B can assist the sharing of application data between the virtual machines and other parts of the host environment 210.

### Host-Independent Storage Access Services

FIG. 8 illustrates an embodiment of host-independent secondary processor environment 220D implementing host-independent storage access services (HISAS) 530. FIG. 8 depicts computer system 110 as coupled to secondary storage 875A and containing host processor 120, host applications 212, host storage 270 and secondary processor environment 220D. Secondary processor environment 220D includes secondary applications processor 130, secondary storage 875B and host-independent storage access services 530.

In an embodiment, HISAS 530 are used to provide access to host storage 270 on computer system 110 independently from the state of host environment 210. The data accessed using HISAS 530 may be application data used by host environment 210 or secondary storage 875A-B that is separate and completely managed by the SAP 130.

In an embodiment, host-independent storage access services allows all connected data storage to be accessible even if host environment 210 is offline (not running host OS/services/applications). HISAS 530 also can be used to retrieve host OS/service/application data when the host corrupted or damaged. Host-independent application synchronization services 520 discussed above can, in an example, synchronize systems settings with main storage, and critical applications and data could be replicated and automatically reinstalled.

An embodiment of SAP 130 can have available secondary storage 875A-B that can be accessed whether or not the computer system 110 powered on. This availability of different host-independent services regardless of host processor 120 status can enhance the capabilities and functions of these services.

For example, if host processor 120 and host environment 210 were rendered unavailable because of hardware problems, HISAS 530 could access both host storage 270 and secondary storage 875A-B. Secondary storage 875A-B can be used to store system recovery information and host storage 270 can be repaired using host-independent management services 510 discussed with FIG. 7 above.

### Host-Independent Multimedia Services

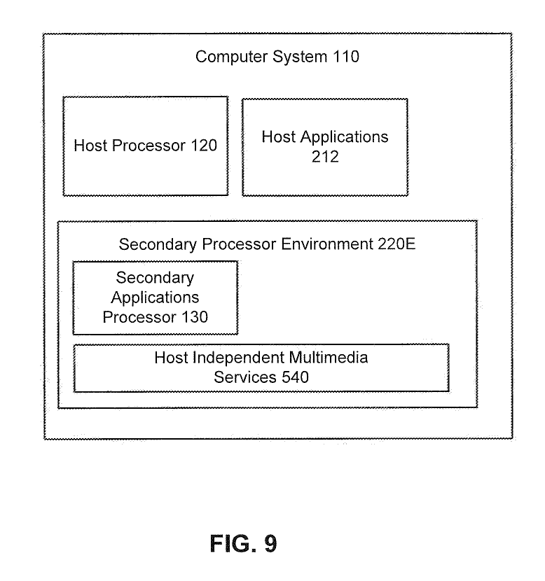

FIG. 9 illustrates an embodiment of host-independent secondary processor environment 220E implementing host-independent multimedia services 540. FIG. 9 depicts computer system 110 as containing host processor 120, host applications 212 and secondary processor environment 220E. Secondary processor environment 220E includes secondary applications processor 130 and host-independent multimedia services 540.

In an embodiment, host-independent multimedia services 540 are used to run multimedia applications independently from host environment 210. Some example multimedia services that can benefit from host-independent multimedia services 540 are VoIP, instant messaging, audio streaming, and audio/video streaming. Host-independent multimedia services 540 provide an environment for running multimedia services independently from host environment 210. By running multimedia applications in secondary processor environment 220E, these services can be made available at all times, not just when host processor 120 is powered on and functional.

Also, by coupling SAP 130 and secondary processor environment 220E to host peripherals, multimedia applications can be provided with better quality of service (QoS) than the QoS provided to the multimedia applications running in host environment 210. This QoS can be improved for example, by adjusting the placement of different functions between processing environments (host-environment 210, secondary processor environment 220E) and otherwise coordinating the states and contexts between running applications.

In an embodiment, because of the host-independence characteristics described above, host-independent multimedia services 540 running on the secondary applications processor 130 provides a dedicated, isolated, and secure environment for running multimedia applications that are not affected by host applications 212 running in the host environment 210.

### Host-Independent Network Proxy Services

FIG. 10 illustrates an embodiment of host-independent secondary processor environment 220F implementing host-independent network proxy services 550. FIG. 10 depicts computer system 110 as containing host processor 120, host applications 212 and network Interface card (NIC) 1010. NIC 1010 includes secondary applications processor 130 and host-independent network proxy services 550.

In an embodiment, host-independent network proxy-services can maintain a presence on network 1020 thereby improving performance. As noted above with FIGS. 4A-B, host-independent services can work to enhance the capabilities of virtual machines. Using SAP 130 to provide a coordinated network proxy service for multiple virtual machines can improve virtual machine 320A-B performance as well.

Using the power independence discussed above, SAP 130 can also provide a network proxy service for responding to network traffic from network 1020 on the behalf of host environment 210 when host environment 210 is shutdown or offline. For example, in a low-power state host-independent network proxy services 550 can respond to ARP request, ICMP echo request without requiring host environment 210 to be powered on.

It should be noted that, in FIG. 10, SAP 130 and host-independent network services are physically shown in NIC 1010.

### Host-Independent Location Services

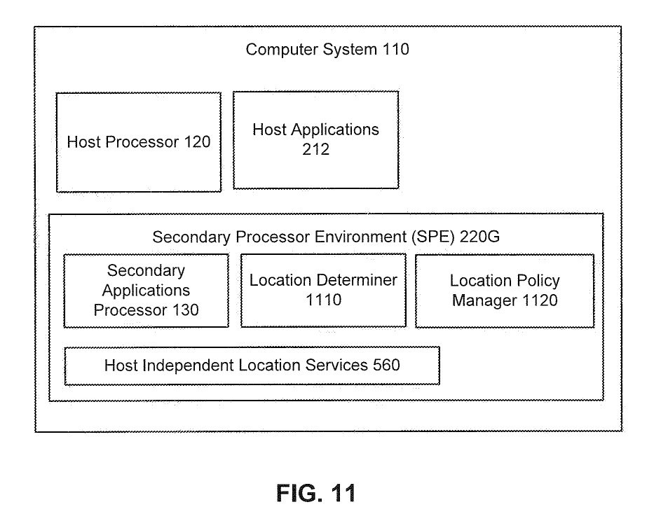

FIG. 11 illustrates an embodiment of host-independent secondary processor environment 220G implementing host-independent location services 560. FIG. 11 depicts computer system 110 as containing host processor 120, host applications 212 and secondary processor environment 220G. Secondary processor environment 220G includes secondary applications processor 130, location determiner 1110, location policy manager 1120 and host-independent location services 560.

In an embodiment, host-independent location services 560 is used to determine the geographic location of computer system 110 using location determiner 1110. Typically, location determiner can be a global positioning system (GPS) component, or SPE 220G can execute an application to determine estimated geographic location by network connectivity characteristics.

Based on the determined location certain services (212, 250) in host environment 210 and SPE 220G can be enabled and disabled. In another embodiment, host applications 212 can be enabled or disabled based on the determined geographic location. In an embodiment, host-environment 210 operates without being “aware” of the host-independent location services 560 running SPE 220G, and cannot alter the operation of the services/applications enabling described above. In another embodiment, location policy manager 1120 can enforce security policies based on the determined geographic location.

In another embodiment, host-independent location services 560 tracks and stores the geographic location of the system. Because of the power independence noted above, this tracking can be ongoing, even if computer system 110 is powered off.

### Host-Independent Security Services

FIG. 12 illustrates an embodiment of host-independent secondary processor environment 220H implementing host-independent security services 570. FIG. 12 depicts computer system 110 as containing host processor 120, host applications 212 and secondary processor environment 220H. Secondary processor environment 220H includes secondary applications processor 130 and host-independent security services 570.

Host-independent security services 570 provides credential management, security offload, and network quarantining services to the host applications. The credentials and network security policies for host applications 212 can be managed independently from host environment 210.

In an embodiment, host-independent security services 570 can be protected and secured to provide an environment for the execution of critical applications (e.g., virus scan, backup) independently from host environment 210. This can increase the reliability and availability of these critical applications.

In an embodiment, security credentials could be managed in SPE 220H. By having credentials managed in host-independent SPE 220H, critical security features can be made secure, isolated and completely unavailable for modification by the user. As noted above with FIG. 11, SPE 220H services can work with host-independent security services 570 to enhance the targeted application of security policy, e.g., the location based security policies discussed above.

### CONCLUSION

While various embodiments of the present invention have been described above, it should be understood that they have been presented by way of example and not limitation. It will be apparent to one skilled in the pertinent art that various changes in form and detail can be made therein without departing from the spirit and scope of the invention. Therefore, the present invention should only be defined in accordance with the following claims and their equivalents.

What is claimed is:

1. A system for providing a secondary processing environment to a computer system that includes a host processor, comprising:
a secondary processor configured to perform a processing service;
a policy manager configured to control interaction between the secondary processor and the host processor;
a service provider configured to provide the processing service to the computer system;
a host-state monitor to monitor state of the host processor, wherein the secondary processor operation is based on the state of the host processor.

2. The system of claim 1, wherein the service provider is further configured to provide the processing service when the host processor is unavailable.

3. The system of claim 1, further comprising:
a primary power source, wherein the primary power source powers the host processor;
an independent power source not operatively coupled to the host processor, wherein if the primary power source is unavailable, the service provider is configured to provide the processing service using power from the independent power source.

4. The system of claim 1, further comprising a virtual machine state monitor to monitor the state of a virtual machine, and wherein the secondary processor operation is further based on the state of the virtual machine.

5. The system of claim 1, wherein the computer system further includes a network interface card configured to interface with a network, wherein the secondary processor is located on the network interface card.

6. The system of claim 1, wherein the processing service is a host-management service.

7. The system of claim 6, wherein the host-management service can, with respect to the computer system, perform one of:
control,
configure,
power on,
power off,
reinstall applications,
repair, and
perform diagnostics.

8. The system of claim 1, wherein the processing service is a synchronizing service.

9. The system of claim 8, wherein the synchronization service can synchronize data between applications.

10. The system of claim 1, wherein the processing service is a storage access service.

11. The system of claim 10, wherein the storage access service provides the computer system access to data storage when the host processor is unavailable.

12. The system of claim 1, wherein the processing service is a multimedia service.

13. The system of claim 12 wherein the multimedia service provides supplemental multimedia processing to the computer system.

14. The system of claim 1, wherein the processing service is a network proxy service configured to maintain a network presence on behalf of the computer system.

15. The system of claim 1, further comprising a location determiner configured to determine the geographic location of the computer system, and wherein the processing service is a location policy service.

16. The system of claim 15, wherein the location policy service can enable or disable capabilities of the computer system based on the determined geographic location of the computer system.

17. The system of claim 15, wherein the location policy service can store values corresponding to the determined geographic location of the computer system over a period of time.

18. The system of claim 1, wherein the processing service is a security service that can enable or disable the capabilities of the computer system.
